(19) United States
(12) Patent Application Publication
(10) Pub. No.: US 2010/0011848 A1
(43) Pub. Date: Jan. 21, 2010

(54) METHOD AND DEVICE FOR IDENTIFYING WHEELS MOUNTED ON A MOTOR VEHICLE

(75) Inventor: Olivier Costes, Tournefeuille (FR)

Correspondence Address: YOUNG & THOMPSON, 209 Madison Street, Suite 500, Alexandria, VA, 22314, US

(73) Assignee: CONTINENTAL AUTOMOTIVE FRANCE, TOULOUSE CEDEX 1 (FR)

(21) Appl. No.: 12/438,565

(22) PCT Filed: Jul. 19, 2007
(86) PCT No.: PCT/EP07/06415

§ 371 Date: Feb. 24, 2009

(30) Foreign Application Priority Data
Aug. 25, 2006 (FR) 0607516

(51) Int. Cl. G01M 15/00; G01M 17/02

(52) U.S. Cl. 73/114.25; 73/146

(57) ABSTRACT

A method for identifying wheels (4) mounted on a vehicle with an engine, wherein each wheel is fitted with a vibration sensor (15) and, initially, in a preliminary phase, with the engine running, the signal delivered by a vibration sensor is analyzed in order to establish a cross-reference table between given values of rotation speeds of the engine and the corresponding values of a parameter characteristic of the signal delivered by this vibration sensor. The identification procedure includes measuring real speeds of rotation of the engine, and comparing the measured values of rotation speed of the engine with the values of rotation speed of the engine calculated from the analysis of the signal delivered by a vibration sensor, so as to validate the identification of the corresponding wheel during a correlation between the measured and calculated values of rotation speed of the engine.

The invention relates to a method and a device for identifying wheels mounted on a vehicle with an engine and each fitted with an electronic module suitable for transmitting, to a central processor unit mounted on the vehicle, signals representative of operating parameters of said wheel, also comprising a code for identifying the latter.

More and more motor vehicles have systems for monitoring and/or measuring parameters comprising sensors mounted on said vehicle.

As an example concerning such systems, it is possible to cite the monitoring systems comprising sensors mounted on each of the vehicle wheels, dedicated to the measurement of parameters, such as pressure and/or temperature of the tires fitted to these wheels, and designed to inform the driver of any abnormal variation of the measured parameter.

These Monitoring Systems Conventionally Comprise:

mounted on each of the vehicle wheels, an electronic module incorporating the measurement sensors, a microprocessor and a radiofrequency transmitter,

and, mounted on the vehicle, a central processor unit for receiving the signals transmitted by the electronic modules, equipped with a computer incorporating a radiofrequency receiver connected to an antenna.

One of the problems that such monitoring systems need to solve lies in the obligation to associate, with each signal received by the receiver of the central processor unit, an item of information relating to the location of the electronic module and therefore the wheel that is at the origin of this signal, this obligation lasting throughout the service life of the vehicle, that is to say having to be observed even after wheel changes or more simply inversions of the position of these wheels.

For these purposes, the monitoring systems must be designed so as to fulfill two functions consisting in:

a function usually called “self-learning”, designed to identify the electronic modules of the wheels actually mounted on the vehicle. This identification function consists in obtaining and storing the identification codes of these electronic modules,

and a location function designed for the location on the vehicle of the identified electronic modules.

Currently, a conventional location method consists in transmitting, by means of antennas mounted on the vehicle, LF (low frequency) signals, called identification request signals, to the electronic modules, and in controlling, in response, the transmission by each of said electronic modules to the central processor unit of a signal comprising an identification parameter of the latter.

The main advantage of such a method lies in the fact that the location procedure is very fast and can allow a virtually instantaneous location after the vehicle has started.

The current usual “self-learning” method consists, for its part, in fitting each electronic module with an acceleration sensor, and in performing the “self-learning” function by using a principle of correlation between the values supplied by these acceleration sensors and the speed of the vehicle measured elsewhere.

The major problem of such a method lies in the fact that it requires a relatively long rolling time before supplying information that is reliable and usable.

Specifically, and in the first place, because of the accuracy of the acceleration sensors, a minimal speed of the order of 20 km/h is required to obtain usable measurement values. In addition, once this rolling threshold is achieved, a minimal rolling time is necessary for the purpose of confirming the correlation between acceleration of the wheels and speed of the vehicle.

For this reason, and despite the potential in terms of responsiveness of certain current methods for locating the wheels, the current monitoring systems are unusable not only when the vehicle is stopped, but also during a relatively long variable period after the vehicle has started.

The object of the present invention is to alleviate this disadvantage and to provide a method for identifying the wheels of a vehicle making it possible to perform the “self-learning” functions with the vehicle stopped, virtually instantaneously after the engine of the vehicle starts.

Another objective of the invention is to provide an identification method that is very efficient in terms of reliability and robustness, the use of which also generates an overall cost that is less than that generated by the use of a current method using accelerometers.

For this purpose, the subject of the invention is a method for identifying wheels mounted on a vehicle with an engine and each fitted with an electronic module suitable for transmitting, to a central processor unit mounted on the vehicle, signals representative of operating parameters of each wheel also comprising a code for identifying the latter.

According to the invention, this identification method consists in incorporating a vibration sensor into each electronic module, and:
in a preliminary characterization phase, in analyzing, with the engine running, the signal delivered by the vibration sensor of an electronic module fitted to a wheel mounted on the vehicle, in order to establish a cross-reference table between predefined values of rotation speeds of the engine (M) and the corresponding values of a parameter characteristic of the signal delivered by the vibration sensor,
and in setting up an identification procedure consisting, on the one hand, in measuring real speeds of rotation of the engine and, on the other hand, for each vibration sensor, in comparing the measured values of rotation speed of the engine with the values of rotation speed of the engine calculated by means of the cross-reference table from the analysis of the signal delivered by said vibration sensor, so as to validate the identification during a correlation between the measured and calculated values of rotation speed of the engine.

It should be noted that, according to the invention, a vibration sensor is intended to be defined in a general manner as any sensor, such as advantageously a sensor of the piezoelectric type, designed to supply a signal that is representative, in terms notably of amplitude and frequency, of the vibrations or mechanical impacts to which said sensor is subjected.

The Invention has Therefore Consisted:

in using a totally novel identification technique based on the measurement, at the electronic modules, of the vibrations generated by the rotation of the engine of a vehicle,

in demonstrating that the values, depending on the engine speed, of one of the parameters characteristic of the signals delivered by the vibration sensors, are identical for all the wheels mounted on one and the same vehicle,

and in demonstrating that the characteristics of the signals delivered by the vibration sensors make it possible, by comparison with measured values of the speed of rotation of the engine, to validate or invalidate the identification of the wheels.

Notably the technique according to the present invention is based on the fact that the wheels of a vehicle all vibrate in a substantially corresponding manner according to the speed of rotation of the engine. More exactly, there is a relationship between the manner in which the wheels vibrate and the speed of rotation of the engine. Therefore it is easy to determine whether a wheel belongs to a vehicle or not. Specifically, if a wheel does not vibrate in a manner corresponding to the speed of rotation of the engine, it is then deduced from this that this wheel does not belong to the vehicle in which this engine is installed.

In the first place, such a technique is very effective in terms of responsiveness because it leads to achieving the identification of the wheels mounted on a vehicle virtually immediately after the engine is started.

In addition, this technique is also very effective in terms of selectivity notably because it uses, as a selection parameter, the speed of rotation of the engine of the vehicle: the probability that the speeds of engines M of two adjacent vehicles is strictly identical is, in effect, virtually zero.

In addition, the method according to the invention has, because of its principle, the crucial advantage of allowing the wheels mounted on a vehicle to be identified, and to do so despite the presence close to this vehicle of other wheels furnished with electronic modules: wheels of an adjacent vehicle, wheel placed close to the vehicle for example after its replacement, etc.

Furthermore, the vibration sensors necessary for the application of the invention consist in sensors of a simple and well-tried technology and lead to an overall installation cost (supply, installation and software adaptation) that is less than that of an installation comprising accelerometers.

Another advantage of the vibration sensors used according to the invention lies in their robustness that is particularly suitable to the severe environmental conditions of motor vehicle electronic modules.

According to an advantageous embodiment of the invention, the user establishes a cross-reference table between measured values of the rotation speeds of the engine and corresponding vibration frequencies of the signal delivered by a vibration sensor.

According to this principle, the identification of the wheels results from a simple comparison between the measured values of the rotation speeds of the engine and the values of rotation speed of the engine deduced from the cross-reference table based on the vibration frequencies generated by this engine rotation at the wheels.

In addition, advantageously according to the invention and in order to increase the reliability and selectivity of the identification method, during each identification procedure, the user takes measurements of the real rotation speeds of the engine during a period of time adapted to make it possible to obtain variations, such as an acceleration, of the speed of the engine.

The invention extends to a device for identifying wheels mounted on a vehicle with an engine and each fitted with an electronic module, comprising:

a vibration sensor incorporated into each electronic module,

means for measuring the real speeds of rotation of the engine,

and means for analyzing the signals delivered by the various vibration sensors, capable, by comparison of each of said signals with the measured values of rotation speed of the engine, of making it possible to validate or invalidate the identification of the wheel fitted with the vibration sensor that is at the origin of said signal and therefore to determine whether this wheel belongs to the vehicle or not.

Other features, aims and advantages of the invention will emerge from the following detailed description with reference to the appended drawings which represent, as a nonlimiting example, a preferred embodiment thereof. In these drawings:

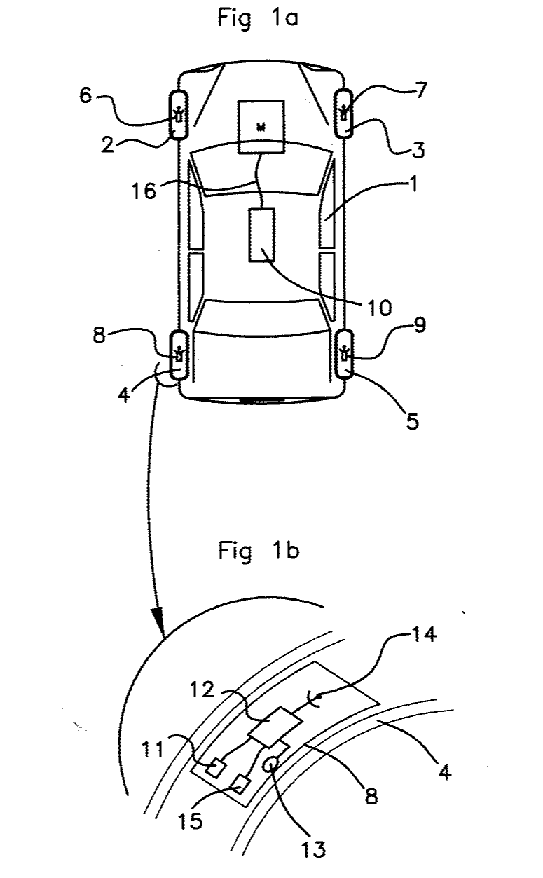

FIG. 1a is a top schematic view of a vehicle furnished with a monitoring system associated with a device according to the invention for identifying wheels mounted on said vehicle,

FIG. 1b is a schematic detail view in perspective representing a portion of a wheel of this vehicle and the electronic module fitted to the latter,

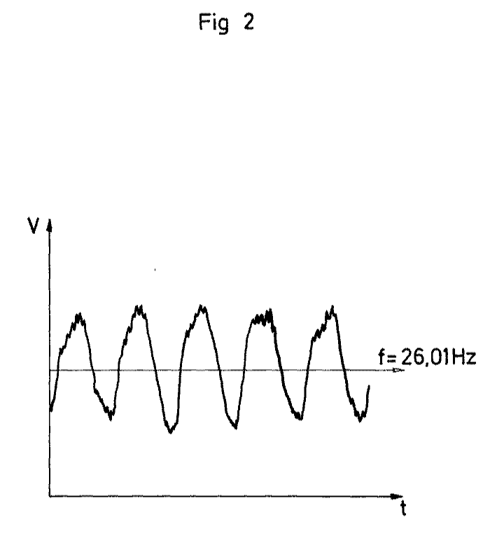

and FIG. 2 represents a signal delivered by a vibration sensor according to the invention for a given engine speed, in the example equal to 750 rpm.

The identification device according to the invention represented as an example in FIGS. 1a and 1b is designed to determine which are the identification codes of the wheels mounted on one and the same vehicle.

This identification device is more specifically designed to be installed on vehicles furnished with a monitoring system such as that, represented in figure la, fitted to a vehicle 1 with an engine M furnished with four wheels conventionally fitted with a tire: two front wheels 2, 3 and two rear wheels 4, 5.

Such monitoring systems conventionally comprise, in the first place, associated with each wheel 2-5, an electronic module 6-9, for example secured to the rim of said wheel so as to be positioned inside the cover of the tire.

Each of these electronic modules 6-9 incorporates, for example (FIG. 1b), sensors 11 dedicated to the measurement of parameters, such as pressure and/or temperature of the tire, connected to a computer unit 12 with a microprocessor electrically supplied by means of a button cell 13, and connected to a radiofrequency transmitter connected to a high-frequency antenna 14.

The monitoring system also comprises a centralized computer or central processor unit 10 situated in the vehicle 1, comprising a microprocessor and incorporating a radiofrequency receiver capable of receiving the signals transmitted by each of the four electronic modules 6-9.

Usually, such a monitoring system and notably its central processor unit 10 are designed so as to inform the driver of any abnormal variation in the parameters measured by the sensors 11 associated with the wheels 2-5.

Associated with this monitoring system and forming an integral part of the latter, the identification device according to the invention comprises a vibration sensor 15, for example of the piezoelectric type, incorporated into each electronic module 6-9 and suitable for supplying a signal representative, in terms notably of amplitude and frequency, of the vibrations or mechanical impacts to which said sensor is subjected (and therefore the wheel on which it is mounted) during the operation of the engine M.

This identification device also uses usual means for measuring the speed of rotation of the engine M, such as a specific sensor the measurements of which are supplied to the central processor unit 10 by using a computer network 16, such as the “CAN” network, of the vehicle 1.

The vibration sensors 15 positioned according to the invention have the following particular features that are determinant according to the principle of the invention:

the values, according to the speed of the engine M, of one of the parameters characteristic of the signals delivered by the vibration sensors 15, are identical for all the wheels 2-5 mounted on one and the same vehicle 1,

the characteristics of the signals delivered by the vibration sensors 15 make it possible, by comparison with measured values of the rotation speed of the engine, to validate or invalidate the identification of the wheels.

These particular features make it possible to use an identification method consisting, according to the invention, for each given model of vehicle 1:

in a preliminary characterization phase, in analyzing, with the engine M running, the signal delivered by the vibration sensor 15 of an electronic module 6-9 fitted to a wheel 2, 5 mounted on the vehicle 1, in order to establish a cross-reference table between predefined values of rotation speeds of the engine M and the corresponding values of a parameter characteristic of the signal delivered by the vibration sensor 15,

and in setting up an identification procedure consisting, on the one hand, in measuring real speeds of rotation of the engine M and, on the other hand, for each vibration sensor 15, in comparing the measured values of rotation speed of the engine with the values of rotation speeds of the engine calculated by means of the cross-reference table, based on the values of the parameter characteristic of the signal delivered by said vibration sensor, so as to validate the identification during a correlation between the measured values of rotation speed of the engine and the values of rotation speed of the engine calculated by means of the cross-reference table.

Furthermore, as a general rule, and as illustrated in FIG. 2, the signals delivered by the vibration sensors 15 are found to have a frequency proportional to the speed of rotation of the engine M. More exactly, an engine M running at a rotation speed of ω revolutions/minute generates a vibration frequency equal to 2 ω (two piston strokes per engine revolution). Therefore, the signal represented in FIG. 2, whose frequency is equal to 26 Hz, corresponds to an engine rotation speed equal to 750 rpm.

Accordingly, each table consists in a cross-reference table between the values of the speeds of rotation of the engine M and the corresponding frequencies of the signal delivered by a vibration sensor 15.

The identification method according to the invention described above therefore makes it possible, by installing a simple, low-cost vibration sensor 15 into each electronic module 6-9 installed on a wheel 2-5 of a vehicle 1, to very quickly and reliably identify all the wheels mounted on this vehicle, thanks to the correspondence that exists between the (known) speed of rotation of the engine and the vibration frequency measured by the vibration sensors installed in each of the wheels of the vehicle.

Therefore, in the example illustrated in FIG. 2, if the engine runs at 750 revolutions/minute, all the wheels vibrating with a frequency of 26 Hz belong to the vehicle in which this engine is installed. On the other hand, if a wheel vibrates at another frequency, it does not belong to this vehicle. It is then easy and quick, when the engine is running and even before the vehicle moves, to sort the wheels belonging to a vehicle from the others (wheels of a nearby vehicle, a replacement wheel stacked nearby, etc.). Only the identification codes of the wheels belonging to a given vehicle are processed by the central processor unit of this vehicle. The other identification codes are ignored.

1. A method for identifying wheels (2-5) mounted on a vehicle(1) with an engine (M) and each fitted with an electronic module (6-9) suitable for transmitting, to a central processor unit (10) mounted on the vehicle (1), signals representative of operating parameters of each wheel also comprising a code for identifying the latter, said identification method being characterized in that it consists in incorporating a vibration sensor (15) into each electronic module (6-9), and:
in a preliminary characterization phase, in analyzing, with the engine (M) running, the signal delivered by the vibration sensor (15) of an electronic module (6-9) fitted to a wheel (2, 5) mounted on the vehicle (1), in order to establish a cross-reference table between predefined values of rotation speeds of the engine (M) and the corresponding values of a parameter characteristic of the signal delivered by the vibration sensor (15),
and in setting up an identification procedure consisting, on the one hand, in measuring real speeds of rotation of the engine (M) and, on the other hand, for each vibration sensor (15), in comparing the measured values of rotation speed of the engine with the values of rotation speed of the engine calculated by means of the cross-reference table from the analysis of the signal delivered by said vibration sensor, so as to validate the identification during a correlation between the measured and calculated values of rotation speed of the engine.

2. The identification method as claimed in claim 1, characterized in that the user establishes a cross-reference table between the values of the rotation speeds of the engine (M) and the corresponding frequencies of the signal delivered by a vibration sensor (15).

3. The identification method as claimed in claim 1, characterized in that, during each identification procedure, the user takes measurements of the real rotation speeds of the engine (M) during a period of time adapted to make it possible to obtain variations, such as an acceleration, of the speed of the engine (M).

4. A device for identifying wheels (2-5) mounted on a vehicle (1) with an engine (M) and each fitted with an electronic module (6-9) suitable for transmitting, to a central processor unit (10) mounted on the vehicle (1), signals representative of operating parameters of each wheel also comprising a code for identifying the latter, said identification device being characterized in that it comprises:
a vibration sensor (15) incorporated into each electronic module (6-9),
means (16) for measuring the real speeds of rotation of the engine (M),
and means for analyzing the signals delivered by the various vibration sensors (15), capable, by comparison of each of said signals with the measured values of rotation speed of the engine, of making it possible to validate or invalidate the identification of the wheel (2-5) fitted with the vibration sensor (15) that is at the origin of said signal.

5. The identification device as claimed in claim 4, characterized in that each vibration sensor (15) consists in a sensor of the piezoelectric type.

6. The identification method as claimed in claim 2, characterized in that, during each identification procedure, the user takes measurements of the real rotation speeds of the engine (M) during a period of time adapted to make it possible to obtain variations, such as an acceleration, of the speed of the engine (M).
